(19) United States
(12) Patent Application Publication
(10) Pub. No.: US 2006/0280678 A1
(43) Pub. Date: Dec. 14, 2006

(54) Apparatus and method for preparing synthesis gas by using barrier discharge reaction

(76) Inventors: Hwa Ung Lee, Seoul (KR); Hyung Keun Song, Gyeonggi-do (KR); Jae Wook Choi, Incheon (KR); Gi Seok Yang, Seoul (KR)

Correspondence Address: KNOBBE MARTENS OLSON & BEAR LLP, 2040 MAIN STREET, FOURTEENTH FLOOR, IRVINE, CA, 92614, US

(21) Appl. No.: 10/558,843

(22) PCT Filed: Oct. 28, 2005
(86) PCT No.: PCT/KR05/03609

§ 371 Date: Nov. 29, 2005

(30) Foreign Application Priority Data
Dec. 7, 2004 (KR) 10-2004-0102655

(51) Int. Cl. C01B 3/24

(52) U.S. Cl. 423/652; 423/650; 48/61; 48/127.9; 423/651

(57) ABSTRACT

Disclosed are an apparatus for preparing hydrogen and carbon monoxide (hereinafter, referred to as “synthesis gas”) from methane and an oxygen containing compound using an atmospheric pressure barrier discharge reaction and a method for preparing the synthesis gas using the same. According to the invention, when the synthesis gas is prepared from the methane and the oxygen containing compound using the barrier discharge plasma at the low temperature, it is possible to obtain the same performance as the case using a high temperature catalyst reaction more economically at a time. In particular, according to the invention, it is possible to save the energy by about 35%, compared to the case using the prior heating only.

### CROSS-REFERENCE TO RELATED APPLICATIONS

This application is a U.S. National Phase under 35 USC §371 of the International Patent Application No.: PCT/KR2005/003609, filed Oct. 28, 2005, which has not yet been published.

### TECHNICAL FIELD

The present invention relates to an apparatus for preparing hydrogen and carbon monoxide (hereinafter, referred to as “synthesis gas”) from methane and an oxygen containing compound using an atmospheric pressure barrier discharge reaction and a method for preparing the synthesis gas using the same.

### BACKGROUND ART

A natural gas is a gas naturally occurring from the underground. Since the natural gas is distributed over a wide area and the reserves thereof are very large, it is considered as very useful resources. Accordingly, it has been actively performed researches on a conversion of the natural gas into a more useful material such as methanol or liquid fuel. Methane occupies most of the natural gas. Since the methane is a saturated hydrocarbon and a very stable material, there are many difficulties in the conversion reaction. In general, the natural gas is converted into liquid fuel or useful compound via the synthesis gas, or may be directly converted into C₂-hydrocarbon or methanol. In these days, according to most natural gas conversion processes which are commercially operated, the natural gas is converted into a synthesis gas by a steam reforming and then methanol or gasoline is synthesized by adopting the synthesis gas as an intermediate.

In the mean time, methane and carbon monoxide of the natural gases are representative greenhouse gases. Researches on the treatment thereof have been recently performed from various fields due to the global warming. In particular, the carbon dioxide should be solved without delay as a carbon tax will be levied in accordance with the international treaties.

The synthesis gas is a compound of hydrogen and carbon monoxide and referred to like that so as to distinguish it from a fuel gas in a use manner. A representative manufacturing method thereof is generally classified into (a) an aqueous gasification method of heating a solid fuel such as cokes or coal into a white-hot state using oxygen (or air) and blowing steam into it at the same time or intermittently, and (b) a steam reforming method of reacting a fluid fuel such as low grade hydrocarbon gas (methane, ethane, propane, butane and the like), naphtha, heavy oil and the like with steam at high temperatures (the reaction is performed under high temperature and pressure conditions without using nickel-based catalyst in the low grade hydrocarbon gas and naphtha and catalyst in the heavy oil). In any cases, a mixed gas containing hydrogen, carbon monoxide and carbon dioxide as the main constituents is produced. The mixed gas is subject to various refining processes of removing the impurities and then regulated to have a gas composition suitable for the synthesis reaction.

The prior steam reforming method uses the catalyst at high temperatures. At this time, the nickel catalyst is conventionally used. Alternatively, as disclosed in a Korean Patent Registration No. 0246079 and a Korean Patent Publication No. 1996-0009892, a noble metal such as Pd, Rd and the like, or alkali metal and alkali earth metal catalyst may be used.

In addition, there is a carbon dioxide reforming method of methane using carbon dioxide, rather than the steam in the steam reforming method. A carbon dioxide reforming reaction of methane is as follows and a strong endothermic reaction.
CH₄+CO₂ [symbol] 2CO+2H₂, ΔH=247 kJ/mol [chemical reaction 1]

The reaction occurs under presence of the catalyst at high temperatures in case of an atmospheric pressure. Similarly to the steam reforming process, the nickel-based catalyst is mainly used at a temperature of about 800° C.

In the mean time, low temperature plasma may be used to decompose stabilized methane. A methane activation by the plasma is very useful in that a methyl radical can be easily obtained due to the high energy of the plasma and a variety of chemical reactions can be induced using the methyl radical.

The plasma can be classified into high temperature plasma and low temperature plasma. The low temperature plasma is mainly used. Among other things, a barrier discharge is used. As the barrier discharge, a silent discharge type-electric discharge is most used. A representative example is a coaxial generator having a dielectric of glass or ceramic interposed between metal electrodes concentrically arranged, such as stainless and the like. A variety of methods for preparing a synthesis gas using the generator have been suggested. For example, there are U.S. Pat. Nos. 6,284,157, 6,045,761, 6,326,407, 6,284,105, 6,027,617, 6,136,278, 6,326,407 and the like.

However, the above methods prepare the synthesis gas simply using the electric discharge and a purity of the synthesis gas produced is not high. In general, in the synthesis gas manufacturing using the barrier discharge, a conversion rate of methane is about 50%. Accordingly, a separation process is further required for the manufacturing so as to manufacture a synthesis gas having a high purity.

In the mean time, a 95% or more conversion rate of methane and carbon dioxide can be obtained at 700˜800° C. if the existing nickel catalyst is used. A following Table 1 shows conversion rates when 5 wt % Ni/Al₂O₃ catalyst is used.

TABLE 1

| Reaction | Conversion rate (%) | | Selectivity (%) | | |
|---|---|---|---|---|---|
| temperature(° C.) | CH₄ | CO₂ | CO | H₂ | H₂/CO ratio |
| 200 | 0 | 0 | 0 | 0 | 0 |
| 300 | 1.36 | 1.82 | 41.95 | 13.16 | 0.31 |
| 400 | 18.51 | 27.16 | 42.57 | 33.17 | 0.78 |
| 500 | 51.15 | 63.40 | 46.90 | 43.65 | 0.93 |
| 600 | 81.86 | 88.62 | 48.10 | 49.41 | 1.03 |
| 700 | 94.82 | 96.81 | 48.71 | 52.07 | 1.07 |
| 800 | 98.73 | 100 | 48.52 | 52.75 | 1.09 |

As shown in Table 1, when the methane and carbon dioxide are reacted under presence of nickel catalyst according to the prior method, pure hydrogen and carbon monoxide are produced with a high purity.

However, when the reaction is performed only with the barrier discharge, the conversion rate is about 40% and hydrocarbons such as ethane, ethylene, propane, propylene, butane and the like are produced in addition to the synthesis gas. It has been reported in this case that even though the catalyst is used together, the catalyst properties are scarcely expressed due to the characteristics of the low temperature plasma having a low internal temperature. Although there is a little change in the selectivity, it just corresponds to a selectivity difference between alkane and alkene.

[Disclosure]

[Technical Problem]

Accordingly, the present invention has been made to solve the above-mentioned problems occurring in the prior art. The object of the present invention is to provide a method for preparing a synthesis gas from methane and an oxygen containing compound wherein catalyst and plasma are used at the same time to prepare a synthesis gas having a high purity. For doing so, it is provided apparatus and method for preparing a synthesis gas having a high purity in a reactor by using barrier discharge plasma, a methane reforming catalyst and an additional heating at a temperature of 200° C. to 400° C. at the same time.

[Technical Solution]

In order to accomplish the object, there is provided an apparatus for preparing a synthesis gas from methane and an oxygen containing compound using an atmospheric pressure barrier discharge reaction, the apparatus comprising an inlet tube 1 mixing and introducing the methane and the oxygen containing compound into a reactor; an internal electrode 3 of the reactor; an external electrode 4 made of a metal thin film of the reactor; a quartz tube 5 constituting a body of the reactor and serving as a dielectric; a methane reforming catalyst layer 8 filled in the atmospheric pressure barrier discharge reactor consisting of the quartz tube 5 so as to induce a catalyst reaction; a heating member 9 mounted to heat the catalyst layer 8 only; a power supply 6 supplying currents to the internal and external electrodes to generate plasma; electric wires 10, 11 in which currents flow; a current-grounded part 12 and an outlet 2 for discharging a product (synthesis gas) prepared as a reaction is completed into an exterior.

According to an embodiment of the invention, the oxygen containing compound may be one selected from a group consisting of carbon dioxide, water and air. Preferably, the carbon dioxide may be used.

According to an embodiment of the invention, when the methane and the oxygen containing compound are mixed, a mixing ratio thereof may be used over an overall range. Preferably, the mixing ratio may be 1:1.

According to an embodiment of the invention, the electrodes may be made of a conductive metal. The internal electrode 3 may have various shapes and be one selected from a group consisting of a general metal line, a thin metal tube and a spring shape.

According to an embodiment of the invention, the external electrode 4 may be made of the metal thin film and coated to be thin on the quartz tube 5 with a thickness of 1 mm or less, preferably 0.5 mm or less. At this time, a thin metal tube may be put around or a metal paste may be used.

The quarts tube 5 constitutes the body of the reactor and serves as a dielectric. In general, although all materials having a dielectric as well as the quartz tube may be used, a reaction characteristic of the invention can be obtained only when the quartz tube is used.

According to an embodiment of the invention, an alternating current or pulse power supply, preferably a high voltage or high frequency alternating current power supply may be used as the power supply 6.

According to an embodiment of the invention, the catalyst of the methane reforming catalyst layer 8 may be one selected from a group consisting of nickel catalyst, noble metal catalyst, alkali metal catalyst and alkali earth metal catalyst. Preferably, the nickel catalyst may be used.

According to an embodiment of the invention, the catalyst may be mounted in the quartz tube 5 by filling glass wool or small glass beads having no reactivity to a lower end of the methane reforming catalyst layer 8.

According to an embodiment of the invention, a thickness of the methane reforming catalyst layer 8 may be about 1/20˜about one time of a length of the heating member, preferably about 1/10.

According to an embodiment of the invention, the heating member may be arranged adjacent to the methane reforming catalyst layer so that the catalyst only is heated, and an electric furnace may be used as the heating member. A temperature may be maintained to be 200˜400° C. by the heating member. When the temperature is higher than 400° C., an economical efficiency of the reaction is poor and when the temperature is lower than 200° C., a rapid reaction does not occur.

In addition, according to the invention, there is provided a method for preparing a synthesis gas from methane and an oxygen containing compound using an atmospheric pressure barrier discharge reaction, the method comprising: a first step of filling a catalyst in a reactor consisting of a quartz tube 5 constituting a body of the reactor and serving as a dielectric at the same time, and heating the methane reforming catalyst layer 8 with a heating member 9; a second step of mixing the methane and the oxygen containing compound when a temperature is maintained to be 200˜400° C. through the first step and then introducing the mixture into the reactor via an inlet tube 1; a third step of applying a high voltage to an internal electrode 3 of the reactor and an external electrode 4 consisting of a metal thin film of the reactor using a power supply 6 simultaneously with the second step to generate plasma in the reactor consisting of the quartz tube 5, thereby preparing a synthesis gas; and a fourth step of discharging the synthesis gas obtained in the third step to an exterior via an outlet 2 of the reactor.

According to an embodiment of the invention, the oxygen containing compound may be one selected from a group consisting of carbon dioxide, water and air. Preferably, the carbon dioxide may be used.

According to an embodiment of the invention, the catalyst of the methane reforming catalyst layer 8 in the first step may be one selected from a group consisting of nickel catalyst, noble metal catalyst, alkali metal catalyst and alkali earth metal catalyst. Preferably, the nickel catalyst may be used.

According to an embodiment of the invention, the catalyst may be mounted in the quartz tube 5 by filling glass wool or small glass beads having no reactivity to a lower end of the methane reforming catalyst layer 8.

According to an embodiment of the invention, a thickness of the methane reforming catalyst layer 8 may be about 1/20˜about one time of a length of the heating member 9, preferably about 1/10.

According to an embodiment of the invention, the heating member 9 in the first step may be arranged adjacent to the methane reforming catalyst layer 8 so that the catalyst only is heated, and an electric furnace may be used as the heating member. A temperature may be maintained to be 200˜400° C. by the heating member. When the temperature is higher than 400° C., an economical efficiency of the reaction is poor and when the temperature is lower than 200° C., a rapid reaction does not occur.

According to an embodiment of the invention, when the methane and the oxygen containing compound are mixed in the second step, a mixing ratio thereof may be used over an overall range. Preferably, the mixing ratio may be 1:1.

According to an embodiment of the invention, the methane and the oxygen containing compound introduced in the second step may react while passing through a region 7a in which the plasma only exists among an area 7 in which the plasma is generated in the reactor in the third step, and complete the reaction while passing through a successive region 7b in which the plasma and the catalyst are mixed.

According to an embodiment of the invention, the external electrode 4 in the third step may be made of a metal coated to be thin on the quartz tube 5 with a thickness of 1 mm or less, preferably 0.5 mm or less.

According to an embodiment of the invention, an alternating current or pulse power supply, preferably a high voltage or high frequency alternating current power supply may be used as the power supply 6 in the third step.

[Advantageous Effects]

According to the invention, when the synthesis gas is prepared from the methane and the oxygen containing compound using the barrier discharge plasma at the low temperature, it is possible to obtain the same performance as the case using a high temperature catalyst reaction more economically at a time. In particular, according to the invention, it is possible to save the energy by about 35%, compared to the case using the prior heating only.

### DESCRIPTION OF DRAWINGS

FIG. 1 is a sectional view showing a synthesis gas preparing apparatus using an atmospheric pressure barrier discharge reaction according to an embodiment of the invention;

FIGS. 2 and 3 are electric wave forms showing an electric feature obtained from a reaction process using an apparatus according to an embodiment of the invention, wherein FIG. 2 is an electric wave form showing an electric feature before the reaction and FIG. 3 is an electric wave form showing an electric feature after the reaction; and

FIG. 4 is a view showing used power of a heating member of an apparatus according to an embodiment of the invention as a temperature is increased.

### DESCRIPTIONS OF REFERENCE NUMERALS FOR IMPORTANT PARTS OR THE DRAWINGS

| | |
|---|---|
| 1: | Inlet tube |
| 2: | Outlet |
| 3: | Internal electrode |
| 4: | External electrode |
| 5: | Quartz tube |
| 6: | Power supply |
| 7: | Area in which the plasma is generated |
| 7a: | Region in which the plasma only exists |
| 7b: | Region in which the plasma and the catalyst are mixed |
| 8: | Methane reforming catalyst layer |
| 9: | Heating member |
| 10, 11: | Electric wires |
| 12: | Current-grounded part |

### BEST MODE

The most important feature of the invention is the quartz tube 5 constituting the body of the reactor and serving as the dielectric. In case that the quartz tube is used as the dielectric, when the temperature is heated to 200° C. or more from the exterior under state that the plasma is generated, thermal and electric properties of the dielectric are changed, so that a micro discharge, which is a characteristic of the barrier discharge, is strongly formed densely around the catalyst layer. As a result of that, the temperature is instantaneously increased to a high temperature and the catalyst is activated due to the high temperature, so that about 100% of conversion rate and a synthesis gas having a high purity can be obtained in a moment.

However, when another dielectric, rather than the quartz tube, is used as the reactor, the above feature cannot be obtained and it is not observed the catalyst activation as the temperature is locally increased.

Another feature of the invention is a shape of the external electrode. The above feature is not obtained just if a metal tube is used as the external electrode or a metal tube is put around. That is, the above feature is obtained when a metal is coated on an outer wall of the reactor.

In other words, it is not possible to obtain the local high temperature required for the production of the synthesis gas having a high purity using a general structure. As described above, only when the specific conditions are satisfied, the above feature can be obtained. This phenomenon has been found through an experiment which will be described later.

According to the invention, it is possible to save the energy by about 35%, compared to the case using the prior heating only.

### MODE FOR INVENTION

Hereinafter, preferred embodiments of the present invention will be described with reference to the accompanying drawings. It should be noted that the following examples are given to illustrate the invention, not to limit a category and a scope of the invention.

### EXAMPLE 1

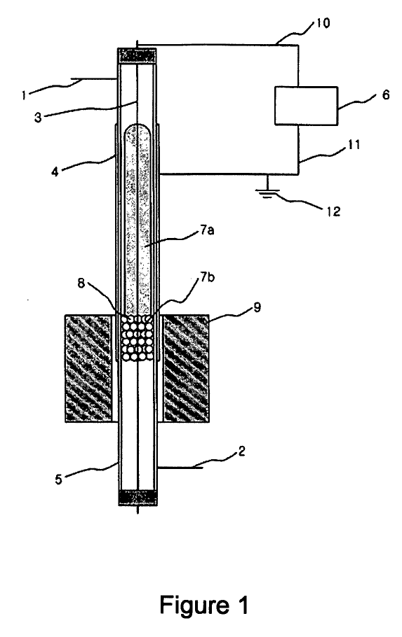

A following experiment was performed to examine an effect of plasma only with a synthesis gas preparing apparatus using an atmospheric pressure barrier discharge reaction, as shown in FIG. 1, under state that an external heating member 9 is not operated.

At this time, a quartz tube 5 having a length of 50 cm, an outer diameter of 8 mm and an inner diameter of 6 mm was used as a reactor. In order to generate plasma in the reactor, silver was coated on an outer wall of the reactor to be a length of 20 cm as an external electrode 4, and a stainless spring having an outer diameter of 4 mm was used as an internal electrode 3. An alternating current power supply having a frequency of 20 kHz and capable of generating up to 10 kV and 100 mA was used as a power supply 6 for generating the plasma. A total 30 cm³/min. of methane and carbon dioxide was introduced via an inlet tube 1 in a flow rate of 15 cm³ per minute, respectively. Glass wool having no reactivity was filled to a lower end of a methane reforming catalyst layer 8 in the reactor, 1 g of 5 wt % Ni/Al₂O₃ catalyst having a size of 10˜20 meshes was filled and then 50 W of power was applied (at this time, the applied voltage was 3 kV). The result is shown in a following Table 2. Meanwhile, in the Table 2, it is defined that a conversion rate is a percentage of a value obtained by dividing a mole of reacted methane or carbon dioxide by a sum of moles of the methane and the carbon dioxide introduced and a selectivity is a percentage of a value obtained by dividing a mole of each material produced by a sum of moles of the methane and the carbon dioxide reacted.

As can be seen from the Table 2, according to the plasma reaction under presence of the catalyst without operating the heating member 9, the conversion rate was low, ethane, propane, butane and the like was produced in addition to the synthesis gas and an amount of the ethane was most.

TABLE 2

| Conversion | | | | | | | | | |
|---|---|---|---|---|---|---|---|---|---|
| rate (%) | | Selectivity (%) | | | | | | | |
| CH₄ | CO₂ | CO | C₂H₂ | C₂H₄ | C₂H₆ | C₃H₆ | C₃H₈ | C₄H₁₀ | H₂/CO ratio |
| 39.5 | 18.4 | 62.86 | 1.10 | 1.17 | 16.16 | 0.69 | 7.80 | 4.54 | 1.15 |

### EXAMPLE 2

The same apparatus as the example I was used. To a lower end of the methane reforming catalyst layer 8 in the reactor was filled the glass wool having no reactivity, and 1 g of 5 wt % Ni/Al₂O₃ catalyst having a size of 20˜48 meshes was filled. An experiment was performed in the same manner as the example 1 while increasing a temperature to 100° C. and 200° C. with the heating member 9 mounted to the outside of the reactor. At this time, a power applied to generate the plasma was 50 W. The result is shown in Table 3.

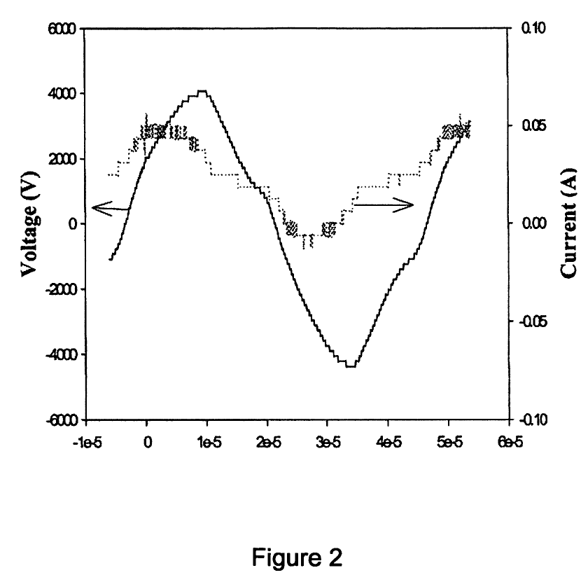

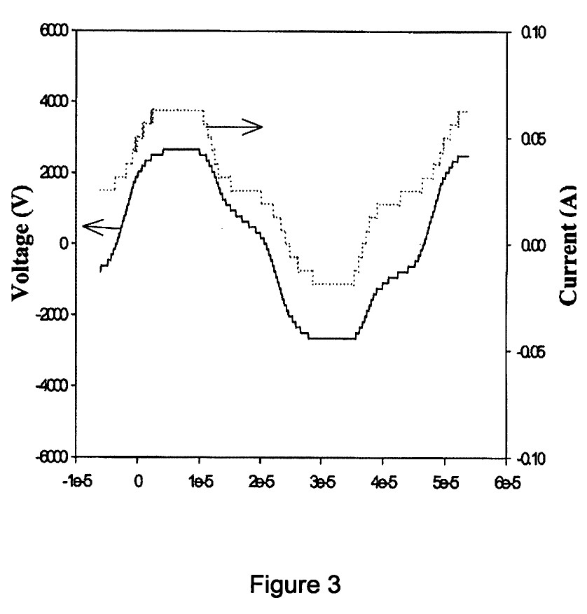

As can be seen from the Table 3, when a temperature of the heating member 9 was 200° C., the conversion rate and selectivity were remarkably increased in a sudden. At this time, many micro discharges were densely generated in the reactor and an internal temperature of the reactor was rapidly increased, so that the catalyst was activated and thus a nearly perfect reaction was carried out. Another feature occurring during the process is an electric phenomenon. As shown in FIGS. 2 and 3, an initial applied voltage was decreased and the current was increased during the reaction. This means that an electric property of the dielectric was changed under conditions of this example to increase the current flow, thereby increasing the internal temperature of the reactor rapidly.

TABLE 3

| Temperature | Conversion | | | | | | | | | |
|---|---|---|---|---|---|---|---|---|---|---|
| of heating | rate (%) | | Selectivity (%) | | | | | | | H₂/CO |
| member(° C.) | CH₄ | CO₂ | CO | C₂H₂ | C₂H₄ | C₂H₆ | C₃H₆ | C₃H₈ | C₄H₁₀ | ratio |
| R.T. | 40.18 | 25.07 | 51.81 | 0.0 | 0.61 | 14.13 | 0.48 | 6.22 | 3.34 | 1.41 |
| 100 | 36.13 | 22.98 | 51.70 | 0.0 | 0.99 | 15.54 | 0.05 | 6.29 | 3.26 | 1.40 |
| 200 | 93.68 | 93.87 | 80.38 | 0.0 | 0.0 | 0.07 | 0.0 | 0.0 | 0.0 | 1.21 |

### EXAMPLE 3

The same apparatus as the example 1 was used. To a lower end of the methane reforming catalyst layer 8 in the reactor was filled the glass wool having no reactivity, and 1 g of 5 wt % Ni/Al₂O₃ catalyst having a size of 10˜20 meshes was filled. A stainless net was closely put around an outer wall of the reactor and silver was coated on the net as the external electrode 4 so as to increase durability of the electrode and then a reaction was performed. 50 W of power was supplied to the reactor and an experiment was performed in the same manner as the example 1 while increasing a temperature to 100° C. and 200° C. with the heating member 9 mounted to the outside of the reactor. The result is shown in Table 4.

As can be seen from the Table 4, also in this example 3, when heated at 200° C., the methane and the carbon dioxide were converted at high conversion rates of 96% or more and a synthesis gas having a high purity was obtained.

TABLE 4

| Temperature | Conversion | | | | | | | | | |
|---|---|---|---|---|---|---|---|---|---|---|
| of heating | rate (%) | | Selectivity (%) | | | | | | | H₂/CO |
| member(° C.) | CH₄ | CO₂ | CO | C₂H₂ | C₂H₄ | C₂H₆ | C₃H₆ | C₃H₈ | C₄H₁₀ | ratio |
| R.T. | 32.00 | 18.46 | 60.30 | 0.0 | 0.36 | 17.60 | 0.11 | 6.47 | 3.21 | 1.14 |
| 100 | 37.12 | 17.25 | 61.30 | 0.0 | 0.78 | 14.77 | 0.50 | 6.98 | 4.07 | 1.29 |
| 200 | 96.75 | 97.28 | 91.74 | 0.0 | 0.0 | 0.04 | 0.0 | 0.0 | 0.0 | 1.13 |

### EXAMPLE 4

The same apparatus as the example 1 was used. To a lower end of the methane reforming catalyst layer 8 in the reactor was filled the glass wool having no reactivity, and 1 g of 5 wt % Ni/Al₂O₃ catalyst having a size of 10˜20 meshes was filled. Gold was coated as the external electrode 4 of the reactor, instead of the silver. 50 W of power was supplied to the reactor and an experiment was performed in the same manner as the example 1 while increasing a temperature to 100° C. and 200° C. with the heating member 9 mounted to the outside of the reactor. The result is shown in Table 5.

As can be seen from the Table 5, also in this example 4, when heated at 200° C., it was obtained a result similar to the examples 2 and 3.

TABLE 5

| Temperature | Conversion | | | | | | | | | |
|---|---|---|---|---|---|---|---|---|---|---|
| of heating | rate (%) | | Selectivity (%) | | | | | | | H₂/CO |
| member(° C.) | CH₄ | CO₂ | CO | C₂H₂ | C₂H₄ | C₂H₆ | C₃H₆ | C₃H₈ | C₄H₁₀ | ratio |
| R.T. | 38.06 | 21.87 | 56.74 | 0.09 | 0.56 | 14.49 | 0.15 | 6.27 | 3.54 | 1.15 |
| 100 | 38.51 | 23.13 | 52.57 | 0.13 | 0.68 | 12.81 | 0.17 | 5.79 | 3.28 | 1.25 |
| 200 | 98.01 | 95.83 | 91.49 | 0.0 | 0.0 | 0.06 | 0.0 | 0.0 | 0.0 | 1.06 |

In the examples 2 to 4, the power consumed for the barrier discharge was 50 W. That is, 180 kJ of energy was consumed on the basis of the reaction for one hour. In addition, the power required to maintain the temperature of 200° C. with the heating member 9 shown in FIG. 1 was 30 W which corresponds to 108 kJ per hour. The sum of the two energies is a total energy consumed in the examples 2 to 4 and corresponds to 288 kJ.

To the contrary, in case of the conventional catalyst reaction, on the basis of the reaction temperature of 700° C. at which the conversion rate of the methane is about 94%, the power consumption required to maintain the temperature of 700° C. is 125 W which corresponds to 450 kJ per hour.

Accordingly, when the invention is used, 64% energy was consumed, compared to the prior method, so that about 36% energy was saved. If the basis temperature is compared with the reaction temperature of 800° C. at which the conversion rate of methane was 98%, the consumed energy was 522 kJ, so that about 45% energy was saved.

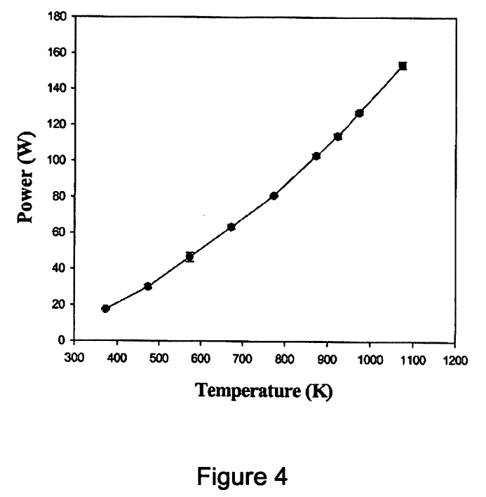

When the electric heating member 9 shown in FIG. 1 is heated to 200° C., about 20% of an energy, which energy is required when it is heated to 800° C., is consumed (refer to FIG. 4).

### EXAMPLE 5

In this example 5, it was examined whether the same result could be obtained using an alumina tube, instead of the quartz tube used as the body of the reactor. In the apparatus same as the example 1, the body of the reactor was replaced with the alumina tube having a same size and silver as the external electrode 4 was coated to be a length of 20 cm on the alumina tube. A reaction experiment was performed under same conditions as the example 1. To a lower end of the methane reforming catalyst layer 8 in the reactor was filled the glass wool having no reactivity, and 1 g of 5 wt % Ni/Al₂O₃ catalyst having a size of 10˜20 meshes was filled. 50 W of power was applied and an experiment was preformed in the same manner as the example 1 while increasing a temperature of the outer heating member 9 from 100° C. to 300° C. The result is shown in Table 6.

As can be seen from the Table 6, in this example 5, even though the temperature was increased to 300° C., the same feature was not obtained, contrary to the examples 1 to 4. This results from dielectric constant properties of the quartz and the alumina as a temperature is increased. Accordingly, it was validated that the reactor using the alumina could not exhibit the same effect in the scope of the invention described herein.

TABLE 6

| Temperature | Conversion | | | | | | | | | |
|---|---|---|---|---|---|---|---|---|---|---|
| of heating | rate (%) | | Selectivity (%) | | | | | | | H₂/CO |
| member(° C.) | CH₄ | CO₂ | CO | C₂H₂ | C₂H₄ | C₂H₆ | C₃H₆ | C₃H₈ | C₄H₁₀ | ratio |
| R.T. | 39.31 | 24.54 | 60.42 | 0.0 | 0.64 | 12.09 | 0.16 | 4.69 | 2.22 | 1.08 |
| 100 | 39.82 | 24.39 | 63.53 | 0.0 | 0.54 | 13.01 | 0.45 | 5.04 | 2.49 | 1.06 |
| 200 | 41.70 | 24.29 | 62.35 | 0.0 | 1.03 | 11.89 | 0.74 | 5.61 | 3.28 | 1.15 |
| 300 | 34.56 | 19.81 | 60.28 | 0.0 | 0.95 | 12.09 | 0.58 | 4.84 | 2.37 | 1.33 |

### EXAMPLE 6

In this example 6, the quartz tube 5 was used as the dielectric for the body of the reactor and a copper tube was used as the external electrode 9, instead of the silver coating. This was made to differentiate the thickness of the external electrode, not the kinds of metals of silver and copper. The copper tube having an inner diameter of 8 mm was closely fitted to the outside of the quartz tube and used as the external electrode. The other experimental conditions were same as the apparatus in the example 1. To a lower end of the methane reforming catalyst layer 8 in the reactor was filled the glass wool having no reactivity, and 1 g of 5 wt % Ni/Al₂O₃ catalyst having a size of 10˜20 meshes was filled. 50 W of power was applied and an experiment was performed while increasing a temperature of the outer heating member 9 from 100° C. to 300° C. The result is shown in Table 7.

As can be seen from the Table 7, in this example 6, although the reactivity became better a little when heated to 300° C., the rapid reaction as in the examples 2 to 4 was not observed.

TABLE 7

| Temperature | Conversion | | | | | | | | | |
|---|---|---|---|---|---|---|---|---|---|---|
| of heating | rate (%) | | Selectivity (%) | | | | | | | H₂/CO |
| member(° C.) | CH₄ | CO₂ | CO | C₂H₂ | C₂H₄ | C₂H₆ | C₃H₆ | C₃H₈ | C₄H₁₀ | ratio |
| R.T. | 37.29 | 21.24 | 56.18 | 0.0 | 0.46 | 15.45 | 0.07 | 6.43 | 2.81 | 1.23 |
| 100 | 42.33 | 24.54 | 51.95 | 0.0 | 0.54 | 14.73 | 0.46 | 6.43 | 3.25 | 1.25 |
| 200 | 44.22 | 24.41 | 54.32 | 0.0 | 0.79 | 14.38 | 0.63 | 6.69 | 3.91 | 1.17 |
| 300 | 49.38 | 30.73 | 51.62 | 0.0 | 0.13 | 12.91 | 0.84 | 6.81 | 4.23 | 1.25 |

While the invention has been shown and described with reference to certain preferred embodiments thereof, it will be understood by those skilled in the art that various changes in form and details may be made therein without departing from the spirit and scope of the invention as defined by the appended claims.

### INDUSTRIAL APPLICABILITY

As described above, according to the invention, when the synthesis gas is prepared from the methane and the oxygen containing compound using the barrier discharge plasma at the low temperature, it is possible to obtain the same performance as the case using a high temperature catalyst reaction more economically at a time. In particular, according to the invention, it is possible to save the energy by about 35%, compared to the case using the prior heating only.

1. An apparatus for preparing a synthesis gas from methane and an oxygen containing compound using an atmospheric pressure barrier discharge reaction, the apparatus comprising:
an inlet tube 1 mixing and introducing the methane and the oxygen containing compound into a reactor;
an internal electrode 3 of the reactor;
an external electrode 4 made of a metal thin film of the reactor;
a quartz tube 5 constituting a body of the reactor and serving as a dielectric;
a methane reforming catalyst layer 8 filled in the atmospheric pressure barrier discharge reactor consisting of the quartz tube 5 so as to induce a catalyst reaction;
a heating member 9 mounted to heat the catalyst layer 8 only;
a power supply 6 supplying currents to the internal and external electrodes to generate plasma;
electric wires 10, 11 in which currents flow;
a current-grounded part 12; and
an outlet 2 for discharging a product (synthesis gas) prepared as a reaction is completed into an exterior.

2. The apparatus according to claim 1, wherein the oxygen containing compound is one selected from a group consisting of carbon dioxide, water and air.

3. The apparatus according to claim 1, wherein the external electrode 4 is made of a metal coated to be thin on the quartz tube 5 with a thickness of 0.5 mm or less.

4. The apparatus according to claim 1, wherein the catalyst of the methane reforming catalyst layer is one selected from a group consisting of nickel catalyst, noble metal catalyst, alkali metal catalyst and alkali earth metal catalyst.

5. The apparatus according to claim 1 or 4, wherein the catalyst is nickel catalyst.

6. The apparatus according to claim 1, wherein a temperature of the heating member 9 is maintained to be 200˜400° C.

7. A method for preparing a synthesis gas from methane and an oxygen containing compound using an atmospheric pressure barrier discharge reaction, the method comprising:
a first step of filling a catalyst in a reactor consisting of a quartz tube 5 constituting a body of the reactor and serving as a dielectric at the same time, and heating the methane reforming catalyst layer 8 with a heating member 9;
a second step of mixing the methane and the oxygen containing compound when a temperature is maintained to be 200˜400° C. through the first step and then introducing the mixture into the reactor via an inlet tube 1;
a third step of applying a high voltage to an internal electrode 3 of the reactor and an external electrode 4 consisting of a metal thin film of the reactor using a power supply 6 simultaneously with the second step to generate plasma in the reactor consisting of the quartz tube 5, thereby preparing a synthesis gas; and
a fourth step of discharging the synthesis gas obtained in the third step to an exterior via an outlet 2 of the reactor.

8. The method according to claim 7, wherein the oxygen containing compound is one selected from a group consisting of carbon dioxide, water and air.

9. The method according to claim 7, wherein the catalyst in the first step is a methane reforming catalyst and is one selected from a group consisting of nickel catalyst, noble metal catalyst, alkali metal catalyst and alkali earth metal catalyst.

10. The method according to claim 7 or 9, wherein the catalyst is nickel catalyst.

11. The method according to claim 7, wherein a temperature of the heating member 9 is maintained to be 200˜400° C.

12. The method according to claim 7, wherein the methane and the oxygen containing compound introduced in the second step react while passing through a region 7a in which the plasma only exists among an area 7 in which the plasma is generated in the reactor in the third step, and complete the reaction while passing through a successive region 7b in which the plasma and the catalyst are mixed.

13. The method according to claim 7, wherein the external electrode 4 is made of a metal coated to be thin on the quartz tube 5 with a thickness of 0.5 mm or less.
